(19) United States
(12) Patent Application Publication
(10) Pub. No.: US 2011/0284788 A1
(43) Pub. Date: Nov. 24, 2011

(54) High Performance Miniature Regulator

(76) Inventor: Andy R. Askew, Pfafftown, NC (US)

(21) Appl. No.: 12/934,686

(22) PCT Filed: Apr. 10, 2009
(86) PCT No.: PCT/US09/40155

§ 371 Date: Dec. 8, 2010

Related U.S. Application Data
(60) Provisional application No. 61/044,166, filed on Apr. 11, 2008.

(51) Int. Cl. F16K 1/32

(52) U.S. Cl. 251/321

(57) ABSTRACT

A pressure regulator is disclosed. The pressure regulator includes a housing having a supply port and an outlet port interconnected by an opening defined in a sealing seat. The pressure regulator also includes a supply valve assembly having a core and an elastic shell disposed thereon, wherein the elastic shell is configured to seal the opening and a diaphragm assembly biased by a range spring and configured to push on the supply valve, the diaphragm assembly having a working surface area.

### CROSS REFERENCE TO RELATED APPLICATION

The present application claims a benefit of priority to U.S. Provisional Application Ser. No. 61/044,166 filed on Apr. 11, 2008 entitled “HIGH PERFORMANCE MINIATURE REGULATOR” the entire contents of which is being incorporated by reference herein.

### BACKGROUND

1. Field

The present disclosure relates generally to pressure regulators, more specifically to high performance miniature regulators.

2. Description of the Related Art

Pressure regulators have long existed in the industrial world. Although many attempts have been made to miniaturize conventional designs, these miniature regulators lack the necessary precision to control pressure in high precision pressure control applications. Pressure regulators are used in a variety of industries. For example, in the medical industry, pressure regulators are used to maintain consistent output setpoints at low output pressures in balloon valve, respiratory and ventilation applications. In those applications the pressure regulators are of relatively small size and light weight, allowing the pressure regulator to operate within the space and weight limitation of portable medical equipment. The pressure regulators operate under various conditions, such as wide variations in the supply pressure feeding the pressure regulator and inherently cyclic nature of the application, which requires high duty cycle life. In addition, the pressure regulators are expected to provide excellent repeatability regardless of supply variance in either filling or evacuating modes. Thus, suitable performance parameters of miniature precision pressure regulators include low supply pressure effect, low supply valve lockup characteristics, and low deadband between the opening of the supply valve and exhaust valve. Prior art miniature pressure regulators exhibit shortcomings in each of these vital aspects.

More specifically, a major problem in the design of miniature pressure regulators is the need to maintain accurate pressure control with a leak free supply valve, while providing a highly responsive device that can instantly compensate for systemic changes. For example, continually variable systemic changes may include changes in supply pressure and downstream flow fluctuations that require fine pressure regulator compensation to maintain the output set point. When no flow requirements are required, the supply valve must seal effectively to prevent the output pressure from slowly creeping up in closed end systems. Therefore there is a need for an improved high performance miniature regulator.

### SUMMARY

Pressure regulators are utilized to maintain a gas or fluid supplied to the system at a predetermined setpoint pressure. Full size pressure regulators often incorporate a pressure-balanced supply valve that negates the influence of the supply pressure on the setpoint pressure. The pressure balance mechanism may be a diaphragm or a sliding seal connected to the supply valve and having effective pressure area equivalent to and opposing that of the seating area of the supply valve. In typical miniature pressure regulators, however, a pressure-balanced supply valve is impractical because of the extreme miniaturization. Miniature pressure regulators may have a footprint 2″ or less and may have a flow capacity of a few scfm at 100 psig supply pressure. Miniature pressure regulators therefore typically incorporate a much simpler unbalanced supply valve design. Unbalanced supply valves are similar to balanced supply valves, but lack the diaphragm or sliding seal balance mechanism that opposes the force of the supply pressure acting upon the sealing area of the supply valve. In an unbalanced valve design, the challenge has been to minimize the so-called “supply pressure effect” while achieving reliable valve operation characteristics. The pressure regulator's supply pressure effect is the change in output pressure setpoint of the pressure regulator as a result of a change in the supply pressure applied to the pressure regulator. In typical unbalanced supply valve pressure regulators, the output pressure decreases as the supply pressure increases.

The supply pressure effect is a function of the force balance system surrounding the control diaphragm. The range spring is configured to apply a force to one side of the diaphragm and is balanced by an equivalent force of the output pressure acting upon the area of the diaphragm on the opposite side. An increasing supply pressure increases the seating force of the supply valve, which must be overcome by the range spring. Therefore less range spring force is available to counter the force of the output pressure. As a result, the output pressure is then reduced to maintain the proper force balance. To achieve these characteristics, the valve and the valve seat must have very small, yet very high precision surfaces.

In unbalanced supply valve miniature pressure regulators, the supply pressure effect is proportional to the ratio of the supply valve seating area and the effective surface area of the control diaphragm. The smaller the ratio, the less effect that supply pressure variation has on the output pressure setpoint. The supply pressure effect in precision pressure regulators may be 1:100 or less, which equates to less than 1 psi change in output pressure for 100 psig change in supply pressure. To achieve this supply pressure effect, the ratio between the supply valve seating area and the surface area of the control diaphragm, in embodiments, may be 1:100 or less.

A variety of design choices influence the setpoint accuracy of a pressure regulator, such as valve lockup characteristic and deadband characteristic. Valve lockup is an abrupt pressure rise that occurs just as the supply valve transitions from a slightly open to a fully closed position. Deadband is the difference in output pressure between the opening of the supply valve and the opening of the exhaust valve.

The magnitude of the deadband is a function of the closing force exerted on the supply valve and the area of the diaphragm. The pressure regulator according to one embodiment of the present disclosure includes a spring-biased valve that opens and closes against a seat. The lockup characteristic depends on the precision of the valve and the seat. For example, a high precision valve and seat can be sealed with relatively little force. As a result, a lockup pressure of a high precision valve is just above the output pressure at which point the pressure regulator is opened. In contrast, to seal a low precision valve and seat, in a high precision miniature regulator, a higher force must be applied to the valve such that the valve is deformed enough to produce a seal. As a result, the valve continues to apply pressure to the outlet of the regulator, raising the output pressure as the valve force is transferred from the bias spring to the valve seat. A pressure regulator with poor lockup characteristics exhibits an elevated output pressure under no-flow conditions over the output pressure during flow conditions. Conventional miniature regulator flat-faced valves often exhibit poor lock up characteristics due to leakage arising from misalignment between the valve and the mating seat. Moreover, because the internal components of a miniature regulator are extremely small, maintaining high precision with even the most modern manufacturing technologies is quite difficult.

In highly accurate applications that experience external influences causing back flow conditions, the valve and the seat are configured to have a low deadband characteristic between the actuation of the supply valve and exhaust valve for proper operation. Conventional miniature pressure regulator designs include a generally flat faced valve seating surface that mates with an annular raised valve seating ring. In this configuration, the actual sealing diameter extends outboard of the basic valve orifice. This inefficiently large seating diameter is then subject to undesirably high and unbalanced valve seating forces arising from the supply pressure. These higher forces act upon the valve in opposition to the bias spring, thereby increasing the required bias spring force to open the valve. This inefficiency leads to higher deadband, which decreases the control accuracy.

Deadband is also dictated by the ratio between the effective valve seating area and the diaphragm surface area. Because the diaphragm overall size, and hence its surface area, is limited by the regulator's footprint dimensions, having a larger valve seating area coupled with a given size diaphragm will necessarily result in a smaller ratio of valve seat area to diaphragm surface area. Consequently, the conventional regulator with its flat valve and seat configuration has high deadband as a result of both the unbalanced forces and its higher seat to diaphragm ratio.

Further, a generally flat valve mating with a flat seat is not configured to accommodate any misalignment with the valve. Accordingly, any misalignment between the valve and seat causes a leak through this most critical area, resulting in poor lock up and inaccurate output pressure.

According to one embodiment of the present disclosure, a pressure regulator is disclosed. The pressure regulator includes a housing having a supply port and an outlet port interconnected by an opening defined in a sealing seat. The pressure regulator also includes a supply valve assembly having a core and an elastic shell disposed thereon, wherein the elastic shell is configured to seal the opening and a diaphragm assembly biased by a range spring and configured to push on the supply valve, the diaphragm assembly having a working surface area.

According to another embodiment of the present disclosure, a pressure regulator is disclosed. The pressure regulator includes a housing having a supply port and an outlet port interconnected by an opening defined in a sealing seat. The pressure regulator also includes a supply valve assembly including a core and an elastic shell disposed thereon, wherein the elastic shell is configured to seal the opening and a diaphragm assembly biased by a range spring and configured to push on the supply valve. The diaphragm assembly includes a working surface area and a relief seat defining a relief passage, wherein the relief seat is configured to be sealed by the core. The pressure regulator further includes an adjustable range screw configured to compress the range spring to set a predetermined setpoint pressure, wherein the diaphragm assembly is configured to unseal the relief seat upon a pressure at the outlet port being higher than the predetermined setpoint pressure.

According to a further embodiment of the present disclosure, a pressure regulator is disclosed. The pressure regulator includes a housing having a supply port and an outlet port interconnected by an opening defined in a conically-shaped sealing seat and a supply valve assembly including a core and an elastic shell disposed thereon, wherein the elastic shell includes a spherical face configured to seal the opening.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a side cross-sectional view of The pressure regulator according to the present disclosure; and

FIG. 2 is an enlarged side cross-sectional view of a valve assembly of the pressure regulator of FIG. 1 in an open configuration; and

FIG. 3 is an enlarged side cross-sectional view of a valve assembly of the pressure regulator of FIG. 1 in a closed configuration.

### DETAILED DESCRIPTION

Particular embodiments of the present disclosure will be described herein below with reference to the accompanying drawings. In the following description, well-known functions or constructions are not described in detail to avoid obscuring the present disclosure in unnecessary detail.

The present disclosure provides a miniature pressure regulator that overcomes shortcomings of conventional miniature pressure regulators. The pressure regulator may be a spring-biased, single stage pressure regulator that includes an overmolded spherical profile pintle supply valve, which mates into a conically shaped valve seat. This configuration permits the valve to seat directly within the valve seat, thereby minimizing the seating area inscribed by the sealing diameter. With a smaller seating area, the ratio of seating area to diaphragm surface area for any given diaphragm is also significantly higher than that of the prior art designs.

The components of the pressure regulator according to the present disclosure may be constructed of various materials, such as molded polymer materials, aluminum, stainless steel and the like. For lighter duty applications, molded polymer materials may be used. For more robust performance, nonferrous materials, such as aluminum may be used, as these would yield a strong, yet lightweight pressure regulator, having the capacity to operate under a high supply pressure (e.g., up to 300 psi). Alternatively, for particular applications seeking ultra-high strength or for environmental or gas media compatibility, a higher strength or corrosive resistant material such as stainless steel could be utilized.

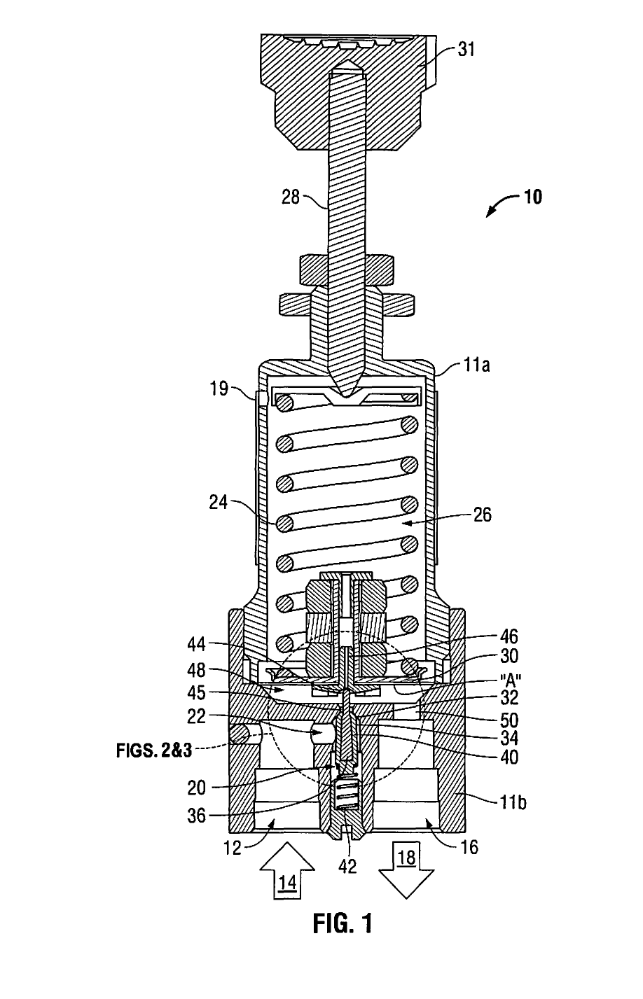

With reference to FIG. 1, a pressure regulator 10 is shown, the pressure regulator 10 includes an upper housing (e.g., bonnet) 11a and a lower housing 11b. The pressure regulator 10 is a spring-biased, single stage pressure regulator. The pressure regulator 10 is coupled to a source of flowing medium (e.g., fluid and/or gas) supplied thereto at a predetermined pressure through the lower housing 11b. More specifically, the medium enters the pressure regulator 10 at a supply port 12 as shown by an arrow 14 and exits the pressure regulator 10 through an outlet port 16 as shown by an arrow 18. The pressure regulator 10 may be coupled to piping via the supply and outlet ports 12 and 16, such as piping providing oxygen in a hospital environment.

The medium under pressure enters the supply port 12 from where the medium flows into a supply valve chamber 20 through a passage 22, which are defined in the lower housing 11b. The pressure regulator 10 includes a range spring 24 disposed within an upper chamber 26 of the upper housing 11a. More specifically, the range spring 24 is disposed between a range screw 28 and a diaphragm assembly 30, thereby exerting a bias force downward against diaphragm assembly 30. The range screw 28 may be adjusted to a predetermined range to control the amount of compression of the range spring 24, which in turn, controls the force exerted on the diaphragm assembly 30. This allows for adjustment of predetermined setpoint pressure. The range screw 28 may include a knob 31 for manual or automated adjustment. In one embodiment, the range screw 28 may include a driver coupling (e.g., fillister slot, Phillips, etc.) for adjustment using a driver. In another embodiment, the range screw 28 may be covered by a tamperproof cover (not shown) to prevent adjustment by unauthorized parties.

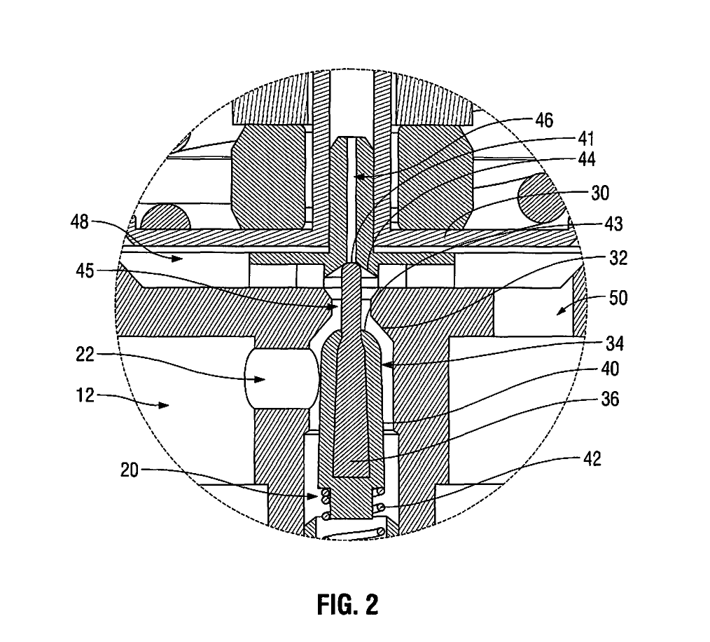

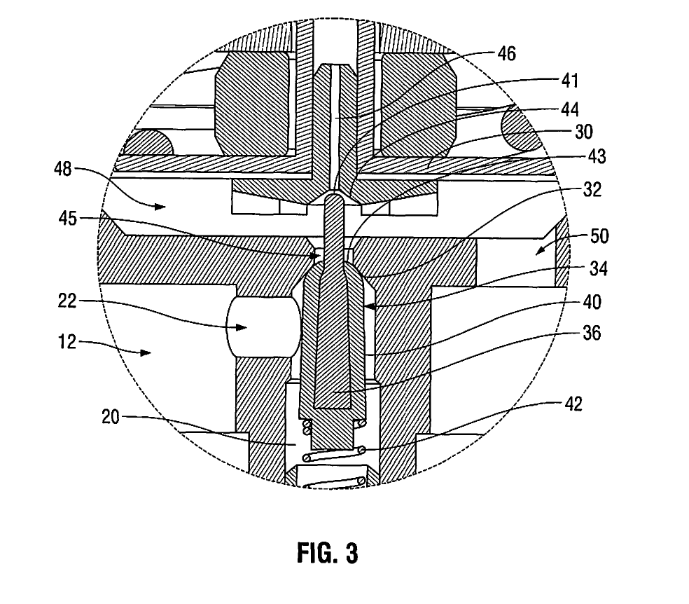

With reference to FIGS. 2 and 3, the diaphragm assembly 30 is biased against an unbalanced supply valve assembly 34. The diaphragm assembly 30 includes a relief seat 44 having a relief passage 46 defined therein. The diaphragm assembly 30 divides the lower portion of the upper chamber 26 into a control chamber 48 with the relief passage 46 serving as a conduit therebetween. The diaphragm assembly 30 includes a working surface area “A” facing the control chamber 48, the surface area “A” comes in contact with the medium as discussed in more detail below with respect to FIGS. 2 and 3. In embodiments, the surface area “A” may be from about 0.2 inches² to about 1.75 inches².

The supply valve assembly 34 is disposed within the supply valve chamber 20 and includes a core 36 and an elastic shell 40 disposed over the core 36. The core 36 may be constructed of a suitable rigid material such as brass or stainless steel and may have a spherical pintle tip (e.g., having a spherical face 41). The shell 40 may be constructed from any type of suitable elastomer (e.g., rubber, polymer, etc.) and may also have a spherical face 43 (e.g., seating surface). The elastomer shell 40 may be formed by overmolding and may be bonded to the core 36.

The supply valve assembly 34 is biased by a return spring 42 in an upward direction opposite the diaphragm assembly 30. When the supply valve assembly 34 is fully biased, the shell 40 rests against a sealing seat 32 having an opening 45 defined therein. The opening 45 acts as a conduit between the control chamber 48 and the supply valve chamber 20. The sealing seat 32 and the opening 45 may be machined within the lower housing 11b. The sealing seat 32 may have a conical shape configured to mate with the spherical face 43 of the shell 40 and may be fabricated as an integral conical valve seat within the lower housing 11b. This configuration permits the shell 40 of the supply valve assembly 34 to seat directly within the sealing seat 32, thereby minimizing the seating area inscribed by the sealing diameter of the shell 40. With a smaller seating area, the ratio of the seating area to the surface area “A” is also significantly lower than that of the prior art designs. In addition, in the closed configuration, the core 36 of the supply valve assembly 40 is also biased against the relief seat 44.

The shell 40 facilitates reliable leakage-free sealing action between the supply valve assembly 34 and the sealing seat 32, resulting in precise and responsive performance. While conventional designs often include an overmolded flat valve seat, overmolding the valve rather than the valve seat is advantageous. By overmolding the valve the resulting configuration maximizes the valve seat orifice size. With an overmolded seat, the effective orifice size increases, due to deformation at the edges of the seating surface. This increases the seating area of the valve seat. The supply pressure acting on the larger seating area increases the seating force of the valve assembly 34. The higher valve seating force requires the range spring 24 to transfer force from the diaphragm assembly 30 to the valve assembly 34 to satisfy the force balance system. The lower force applied to the diaphragm assembly 30 ultimately reduces the setpoint pressure which decreases the pressure regulator's accuracy. While the overmolded valve may deform, the orifice size and seating area remains consistent.

The geometry of the supply valve assembly 34 and the sealing seat 32 also greatly improves performance of the pressure regulator 10. The spherical faces 41 and 43 of the supply valve assembly 34 serve multiple functions. The spherical surface of face 43 is inherently suited accommodate misalignment between the supply valve assembly 34 and its sealing seat 32 since the supply valve assembly 34 seats tightly with a circular contact pattern upon any degree of axial misalignment. Moreover, the conically shaped sealing seat 32 serves as an introductory tapered funnel to guide the supply valve assembly 34 into its natural position in the seating surface relative to the smaller opening of the conical seat. The cone shape of the sealing seat 32 is tapered and terminates at the orifice diameter of the opening 45. This configuration eliminates one particular flaw of conventional designs having a flat valve seat, which may be prone to leakage when the valve is axially misaligned thereby causing the valve to hang up or become caught in a partially open position.

In addition, the spherically shaped overmolded shell 40 allows the opening 45 to be sized to maintain the smallest diameter necessary for the requisite flow capacity of the pressure regulator 10. Since the spherical face 43 is configured to seat at the interface of the opening 45 and the conical sealing seat 32, the effective valve seating area is minimized for the lowest possible ratio with respect to surface area “A” of the diaphragm assembly 30, thereby resulting in lowest supply pressure effect and lowest deadband performance for a given footprint size regulator. Namely, the seating area of the supply valve assembly 34 (e.g., contact area between the spherical face 43 and the sealing seat 32) is minimized to form a ring-shaped contact pattern having a ratio of at least 1:100 with respect to the surface area “A” of the diaphragm assembly 30.

As shown in FIG. 2, when the spring 24 is compressed, the spring 24 exerts a force larger than the force exerted in the opposite direction by the return spring 42 under normal pressure (e.g., atmospheric pressure). In the absence of excessive pressure in the control chamber 48, the downward movement due to the force exerted by the spring 24 moves the diaphragm assembly 30 down, which pushes down the supply valve assembly 30 and moves the valve assembly 34 off of the sealing seat 32 opening a path for the supplied medium to travel from the supply valve chamber 20 through the valve seat opening 45 and into the control chamber 48. The medium then passes further through an outlet passage 50, which connects the control chamber 48 with the outlet 16, and into the outlet port 16.

As the medium flows into the outlet port 16, pressure increases and is commuted through the outlet passage 50 and into the control chamber 48. The pressure present in control chamber 48 exerts a force against the diaphragm assembly 30, namely, the surface area “A.” The pressure on the diaphragm assembly 30 is counterbalanced by the force exerted by range spring 24 based on the adjustments made to the range screw 28.

As the pressure continues to rise, the force generated on the diaphragm assembly 30 by the pressure in the control chamber 48 surpasses the force imparted by the range spring 24. As a result, the diaphragm assembly 30 moves upward along with the supply valve assembly 34 assisted by the return spring 42. Once the pressure in control chamber 48 reaches the setpoint pressure, based on the setting of the adjustment screw 28, the supply valve assembly 34 contacts the sealing seat 32 and seals off the opening 45 preventing any medium from entering the control chamber 48 as shown in FIG. 3. The opening 45 is sealed by the shell 40 coming into contact with the sealing seat 32, this prevents further flow of medium from the supply valve chamber 20 into the control chamber 48, the outlet passage 50 and the outlet port 16. With no medium flowing into the control chamber 48, the outlet passage 50 and the outlet port 16, the pressure in these chambers equalizes to the setpoint of the pressure regulator 10 as set by the adjustment screw 28.

Once the downstream pressure in the control chamber 48, the outlet passage 50 and the outlet port 16 falls, the force generated on surface area “A” is reduced. The downward force of range spring 24 on the diaphragm assembly 30 moves the diaphragm assembly 30 down, which to pushes the supply valve assembly 30 down and off the sealing seat 32, opening a path for the supply medium to travel from the supply valve chamber 20 through the valve seat opening 45 and into the control chamber 48, thereby restarting the pressure regulation process as shown in FIG. 2.

If the downstream pressure in the control chamber 48, the outlet passage 50 and the outlet port 16 rises above the setpoint due to some occurrence in the downstream piping or if the range spring 24 is decompressed by backing out the range screw 28, then the pressure in the control chamber 48 acting upon surface area “A” moves the diaphragm assembly 30 in an upward direction. The supply valve assembly 34 is also pushed upwards by the return spring 42 but is prevented from following the diaphragm assembly 30 in an upward direction by the shell 40 coming in contact with sealing seat 32. The diaphragm assembly 30 continues to travel upwards until the tip of the core 36 of the supply valve assembly 30 disconnects with the relief seat 44. This allows pressurized medium to flow from the control chamber 48 through the relief passage 46 into the upper chamber 26 thereby reducing the medium pressure present in control chamber 48. The medium then fills the upper chamber 26 and exits the pressure regulator 10 to atmosphere through a vent port 19 (FIG. 1).

The pressure regulator according to the present disclosure may alternatively be configured as a non-relieving design by closing the relief passage, 46. This configuration is suitable for various applications that require non-relieving, no bleed, leak-free performance.

The described embodiments of the present disclosure are intended to be illustrative rather than restrictive, and are not intended to represent every embodiment of the present disclosure. Various modifications and variations can be made without departing from the spirit or scope of the disclosure as set forth in the following claims both literally and in equivalents recognized in law.

1. A pressure regulator comprising:
a housing including a supply port and an outlet port interconnected by an opening defined in a sealing seat;
a supply valve assembly including a core and an elastic shell disposed thereon, wherein the elastic shell is configured to seal the opening; and
a diaphragm assembly biased by a range spring and configured to push on the supply valve assembly, the diaphragm assembly having a working surface area

2. The pressure regulator according to claim 1, wherein the elastic shell includes a spherical face.

3. The pressure regulator according to claim 2, wherein the sealing seat has a conical shape.

4. The pressure regulator according to claim 3, wherein a ratio between the working surface area and a contact area between the spherical face of the elastic shell and the conical shape of the sealing seat is at least 100:1.

5. The pressure regulator according to claim 1, wherein the supply valve assembly includes a return spring configured to bias the core and the elastic shell.

6. The pressure regulator according to claim 1, further comprising:
an adjustable range screw configured to compress the range spring to set a predetermined setpoint pressure.

7. The pressure regulator according to claim 6, wherein the diaphragm assembly includes a relief seat defining a relief passage, the relief seat configured to be sealed by the core.

8. The pressure regulator according to claim 7, wherein upon a pressure at the outlet port being higher than the predetermined setpoint pressure the diaphragm assembly is pushed upwards unsealing the relief seat.

9. A pressure regulator comprising:
a housing including a supply port and an outlet port interconnected by an opening defined in a sealing seat;
a supply valve assembly including a core and an elastic shell disposed thereon, wherein the elastic shell is configured to seal the opening;
a diaphragm assembly biased by a range spring and configured to push on the supply valve assembly, wherein the diaphragm assembly includes a working surface area and a relief seat defining a relief passage, the relief seat configured to be sealed by the core; and
an adjustable range screw configured to compress the range spring to set a predetermined setpoint pressure, wherein the diaphragm assembly is configured to unseal the relief seat upon a pressure at the outlet port being higher than the predetermined setpoint pressure.

10. The pressure regulator according to claim 9, wherein the elastic shell includes a spherical face.

11. The pressure regulator according to claim 10, wherein the sealing seat has a conical shape.

12. The pressure regulator according to claim 11, wherein a ratio between the working surface area and a contact area between the spherical face of the elastic shell and the conical shape of the sealing seat is at least 100:1.

13. The pressure regulator according to claim 9, wherein the supply valve assembly includes a return spring configured to bias the core and the elastic shell.

14. The pressure regulator according to claim 9, wherein the housing includes a vent port for venting excess pressure through the relief passage.

15. A pressure regulator comprising:
a housing including a supply port and an outlet port interconnected by an opening defined in a conically-shaped sealing seat; and
a supply valve assembly including a core and an elastic shell disposed thereon, wherein the elastic shell includes a spherical face configured to seal the opening.

16. The pressure regulator according to claim 15, further comprising:
a diaphragm assembly biased by a range spring and configured to push on the supply valve, the diaphragm assembly having a working surface area.

17. The pressure regulator according to claim 16, wherein a ratio between the working surface area and a contact area between the spherical face of the elastic shell and the conically-shaped sealing seat is at least 100:1.

18. The pressure regulator according to claim 16, further comprising:
an adjustable range screw configured to compress the range spring to set a predetermined setpoint pressure.

19. The pressure regulator according to claim 15, wherein the supply valve assembly includes a return spring configured to bias the core and the elastic shell.

20. The pressure regulator according to claim 15, wherein the elastic shell is formed by overmolding an elastomer selected from the group consisting of rubber and polymer.
